(19) United States
(12) Patent Application Publication
(10) Pub. No.: US 2023/0047459 A1
(43) Pub. Date: Feb. 16, 2023

(54) METHOD AND SYSTEM FOR ANALYZING VIEWING DIRECTION OF ELECTRONIC COMPONENT, COMPUTER PROGRAM PRODUCT WITH STORED PROGRAM, AND COMPUTER READABLE MEDIUM WITH STORED PROGRAM

(71) Applicant: FOOTPRINTKU INC., Kaohsiung city (KR)

(72) Inventors: YAN-JHIH WANG, Kaohsiung City (TW); KUAN-HSIANG TSENG, Kaohsiung City (TW); HSIANG-MIN KUO, Kaohsiung City (TW); TZUNG-PEI HONG, Kaohsiung City (TW); SHIH-FENG HUANG, Kaohsiung City (TW); YI-TING CHEN, Kaohsiung City (TW)

(21) Appl. No.: 17/399,419

(22) Filed: Aug. 11, 2021

(51) Int. Cl. G06K 9/32; G06T 7/70; G06K 9/20; G06K 9/62; G06N 3/02

(52) U.S. Cl. CPC G06K 9/3208; G06T 7/70; G06K 9/2063; G06K 9/6217; G06N 3/02; G06T 2207/20084; G06T 2207/20036

(57) ABSTRACT

A method for analyzing a viewing direction of an electronic component includes inputting a package type and a file image of an electronic component, with the file image having at least one engineering drawing image, and the at least one engineering drawing image being a view of the electronic component in at least one viewing direction; querying and acquiring a viewing direction detection model meeting the package type from a database, with the database storing respective viewing direction detection models of different package types of electronic components; inputting the file image into the viewing direction detection model of the package type to identify the viewing direction of the at least one engineering drawing image; and outputting the viewing direction of the at least one engineering drawing image of the electronic component.

### BACKGROUND OF THE INVENTION

### 1. Field of the Invention

The present invention generally relates to an analysis method and, more particularly, to a method and system for acquiring a viewing direction of an electronic component by analyzing an engineering drawing image of the electronic component, a computer program product with a stored program, and a computer readable medium with a stored program.

### 2. Description of the Related Art

In the product datasheets of semiconductor related electronic components, views of the electronic component in different viewing directions are drawn, such as a top view, a bottom view, a side view, a cross-sectional view and a land pattern view. Since there are various electronic components, designers such as layout engineers and hardware engineers with less working experience cannot distinguish the viewing directions of various electronic component views correctly. It is especially easy to read the top view and the bottom view incorrectly.

In light of this, it is necessary to improve the conventional method for analyzing a viewing direction of an electronic component.

### SUMMARY OF THE INVENTION

It is therefore an objective of the present invention to provide a method for analyzing a viewing direction of an electronic component, which can acquire a viewing direction of an electronic component by analyzing an engineering drawing image of the electronic component.

It is another objective of the present invention to provide a method for analyzing a viewing direction of an electronic component, which can correct a detection position of the engineering drawing image of the electronic component.

It is yet another objective of the present invention to provide a system for analyzing a viewing direction of an electronic component, a computer program product with a stored program, and a computer readable medium with a stored program, for executing the above method.

It may be understood by one of ordinary skill in the art that the “expert system” used herein refers to a computer intelligent program system with special knowledge and experience. Generally speaking, the expert system includes a knowledge base and an inference engine.

It may be understood by one of ordinary skill in the art that the “computer” used herein refers to a variety of data processing apparatuses having a specific function and implemented with hardware or hardware and software, such as a server, a virtual machine (e.g. Amazon and Azure), a desktop computer, a laptop, a tablet or a smartphone.

It may be understood by one of ordinary skill in the art that the “computer program product” used herein refers to an object which is stored with a computer readable program and is not limited by an external form thereof.

It may be understood by one of ordinary skill in the art that the “computer readable medium” used herein refers to a carrier on which software is stored, and the software may be accessed by a computer and typically includes an optical disc, a hard disk, a Universal Serial Bus (USB) flash drive, various memory cards, and cloud or virtual memory spaces.

It may be understood by one of ordinary skill in the art that the “processor unit” used herein refers to any electronic chip with data storage, operation and signal generation functions, or electronic equipment having the electronic chip. For example, the electronic chip may be a central processing unit (CPU), a micro control unit (MCU), a digital signal processor (DSP), a field programmable gate array (FPGA) or a system on chip (SoC). The electronic equipment may be a programmable logic controller (PLC) or an Arduino UNO. The processor unit may be selected by those of ordinary skill in the art according to operation efficiency, price, volume limitation or required function, etc.

It may be understood by one of ordinary skill in the art that the “database” used herein refers to a group of related electronic data collected and stored in a hard disk, a memory or a combination thereof. Electronic data may be processed by virtue of grammatical functions provided by a database management system (DBSMS), such as add, read, search, update, delete, etc. The database management system may management electronic data by different data structure models, such as a relational model, a hierarchical model, a network model or an object-oriented model. The present invention is described below by taking the relational database management system as an example, but is not limited in this regard.

A method for analyzing the viewing direction of the electronic component according to the present invention includes inputting a package type and a file image of an electronic component, with the file image having at least one engineering drawing image, and the at least one engineering drawing image being a view of the electronic component in at least one viewing direction; querying and acquiring a viewing direction detection model meeting the package type from a database, with the database storing respective viewing direction detection models of different package types of electronic components; inputting the file image into the viewing direction detection model of the package type to identify the viewing direction of the at least one engineering drawing image; and outputting the viewing direction of the at least one engineering drawing image of the electronic component.

The present invention discloses a computer program product with the stored program and a computer readable medium with the stored program which are capable of performing the above method after a computer system loads and executes the stored program. Therefore, the above method may be used, interchanged or executed conveniently, such that the method for analyzing the viewing direction of the electronic component is widely applied to other application software.

A system for analyzing the viewing direction of the electronic component according to the present invention includes an input unit, configured to input a package type and a file image of an electronic component, with the file image having at least one engineering drawing image, and the at least one engineering drawing image having a view of the electronic component in at least one viewing direction; a database unit, configured to store respective viewing direction detection models of different package types of electronic components; an object detection unit, configured to detect at least one engineering drawing image from the file image to identify a viewing direction of the at least one engineering drawing image; and a processor unit, electrically connected to the input unit, the database unit and the object detection unit, with the processor unit being configured to query a viewing direction detection model meeting the package type of the electronic component from the database unit and input the file image into the viewing direction detection model to make the viewing direction detection model detect the at least one engineering drawing image from the file image to identify and output the viewing direction of the at least one engineering drawing image.

Accordingly, according to the method and system for analyzing the viewing direction of the electronic component, the computer program product with the stored program and the computer readable medium with the stored program according to the present invention, data meeting a package type of the electronic component can be queried from the database to acquire a viewing direction detection model for identifying the viewing direction of at least one engineering drawing image of the electronic component, and the viewing direction of the at least one engineering drawing image is identified by the viewing direction detection model. Thus, the present invention has the effect of reducing artificial misjudgment.

In an example, the at least one engineering drawing image includes at least one of a top view, a bottom view, a side view, a cross-sectional view and a land pattern view. Thus, the method for analyzing the viewing direction of the electronic component has the effect of expanding the application range.

In an example, the viewing direction detection model adopts an object detection neural network model to detect the at least one engineering drawing image and perform a box selection to generate at least one view area, and the viewing direction detection model identifies an engineering drawing image in the at least one view area to identify the viewing direction of the at least one engineering drawing image. Thus, the method for analyzing the viewing direction of the electronic component has the effects of high execution speed and excellent detection accuracy.

In an example, the viewing direction detection model detects the at least one engineering drawing image and performs a box selection to generate at least one view area, detects numbers, annotations or/and symbols in the at least one view area, performs a box selection to generate at least one labeling area and acquire image coordinates of the labeling area, and updates a range boundary of the at least one view area according to the image coordinates of the labeling area to make the updated at least one view area not cover the labeling area. Thus, dimension information of the engineering drawing image can be excluded from the view area, and the effect of improving the identification accuracy of the viewing direction can be achieved.

In an example, a dimension boundary line, a dimension line, an arrow or/and a leader line are excluded from the at least one view area by a morphology image processing technology to reduce the range boundary of the at least one view area. Thus, dimension information of the engineering drawing image can be excluded from the view area, and the effect of improving the identification accuracy of the viewing direction can be achieved.

In an example, the system for analyzing the viewing direction of the electronic component further includes a target detection unit, with the target detection unit being electrically connected to the processor unit. The object detection unit detects the at least one engineering drawing image and performs a box selection to generate at least one view area, the processor unit detects numbers, annotations or/and symbols in the at least one view area by the target detection unit and performs a box selection to generate at least one labeling area and acquire image coordinates of the labeling area, and the target detection unit updates a range boundary of the at least one view area according to the image coordinates of the labeling area to make the updated at least one view area not covering the labeling area. Thus, dimension information of the engineering drawing image can be excluded from the view area, and the effect of improving the identification accuracy of the viewing direction can be achieved.

In an example, the processor unit excludes a dimension boundary line, a dimension line, an arrow or/and a leader line from the at least one view area by a morphology image processing technology to reduce the range boundary of the at least one view area. Thus, dimension information of the engineering drawing image can be excluded from the view area, and the effect of improving the identification accuracy of the viewing direction can be achieved.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 is a flowchart of a method for analyzing a viewing direction of an electronic component according to the present invention.

FIG. 2 is a diagrammatic view of a view area correction of a method for analyzing a viewing direction of an electronic component according to the present invention.

FIG. 3 is a block diagram of a system for analyzing a viewing direction of an electronic component according to the present invention.

In the various figures of the drawings, the same numerals designate the same or similar parts. Furthermore, when the terms “front”, “rear”, “left”, “right”, “upper (top)”, “lower (bottom)”, “inner”, “outer” and “side” and similar terms are used hereinafter, it should be understood that these terms have reference only to the structure shown in the drawings as it would appear to a person viewing the drawings, and are utilized only to facilitate describing the invention.

### DETAILED DESCRIPTION OF THE INVENTION

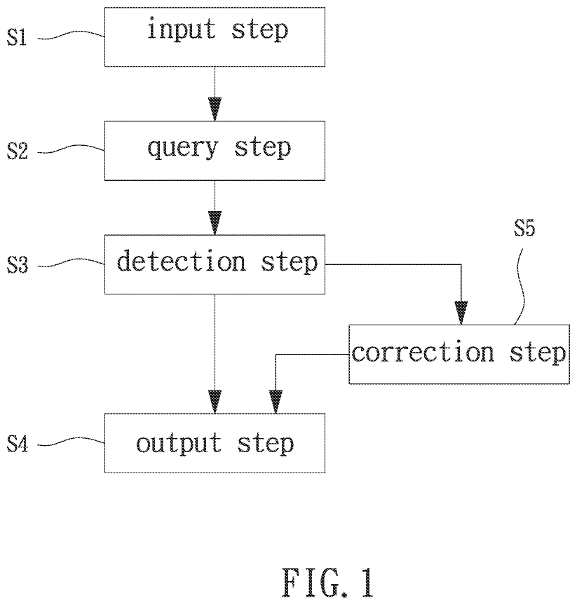

Referring to FIG. 1 which is a preferred embodiment of a method for analyzing a viewing direction of an electronic component according to the present invention, the method includes an input step S1, a query step S2, a detection step S3 and an output step S4.

The input step S1 includes inputting a package type and a file image of an electronic component. The file image has at least one engineering drawing image, and the at least one engineering drawing image is a view of the electronic component in at least one viewing direction. In this embodiment, the file image may be a digital image of an electronic component engineering drawing specification, and the at least one engineering drawing image includes at least one of a top view, a bottom view, a side view, a cross-sectional view and a land pattern view. The file image may convert a PDF file content of the electronic component engineering drawing specification into a picture format to generate the file image for use in the subsequent step. However, the generation model of the file image is not limited in this regard.

The query step S2 queries a database to acquire a viewing direction detection model meeting the package type. Specifically, the database may store respective viewing direction detection models of a plurality of different package types of electronic components in advance so as to identify the viewing direction of the engineering drawing image of the electronic component. For example, the plurality of package types may include package types of the electronic components such as BGA, QFP, PLCC, DIP, SIP, SOP, SOJ, connector, etc. Taking the BGA package type as an example, when the basic model is trained for the first time, an image for training may include a top view image, a bottom view image, a side view image, a cross-sectional view image and a land pattern view of the BGA package type. It is noted that images for training of different package types may not have the land pattern view, which may be understood by one of ordinary skill in the art.

The detection step S3 inputs the file image into the viewing direction detection model of the package type to identify the viewing direction of at least one engineering drawing image. In this embodiment, the viewing direction detection model may adopt object detection neural network models such as YOLO series, RCNN or SegNet to detect at least one engineering drawing image of the file image and perform a box selection to generate at least one view area. Image coordinates of the at least one engineering drawing image located in the file image may be acquired to identify the engineering drawing image in the at least one view area.

It is noted that the viewing directions that can be identified by the respective viewing direction detection models of the plurality of different package types of electronic components are different according to the drawing requirements of the electronic components. Namely, the viewing direction detection model of one electronic component may identify the viewing directions of the top view, the bottom view, the side view, the cross-sectional view and the land pattern view, and the viewing direction detection model of another electronic component can only identify the viewing directions of the top view, the bottom view, the side view and the land pattern view.

The output step S4 outputs the viewing direction of the at least one engineering drawing image of the electronic component. For example, the viewing direction may be labeled adjacent to the at least one engineering drawing image of the file image in a text manner, such that a user can know the viewing direction of the engineering drawing image.

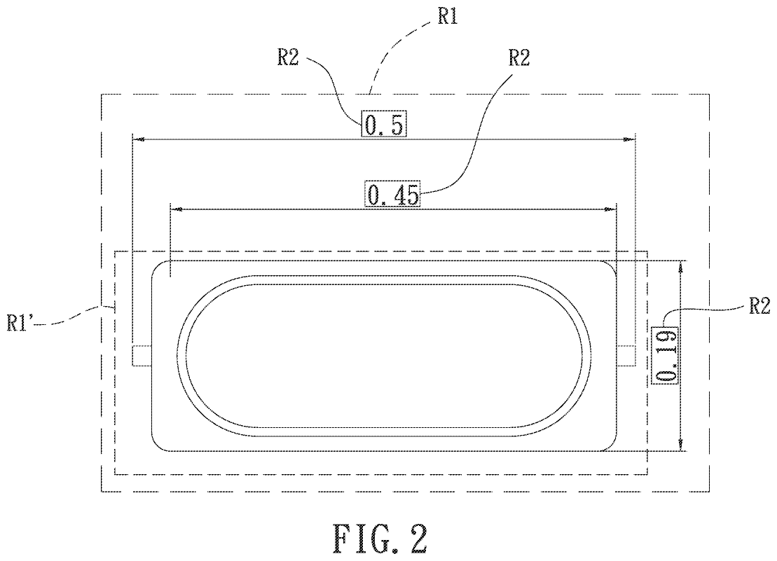

Referring to FIG. 2, the method for analyzing the viewing direction of the electronic component according to the present invention may further include a correction step S5 which can correct the at least one view area R1 box-selected by the viewing direction detection model when the viewing direction detection model detects at least one engineering drawing image of the file image to exclude the dimension information of the engineering drawing image from each view area R1. Thus, only view information of the engineering drawing image in each updated view area R1′ is remained. The dimension may include a dimension boundary line, a dimension line, an arrow, a leader line, a number, an annotation, a symbol, etc., which may be understood by one of ordinary skill in the art.

Specifically, the correction step S5 detects the number, the annotation or/and the symbol in the at least one view area R1 through convolutional neural network-based target detection neural network models such as EAST, RCNN, Fast RCNN, Faster RCNN or SSD and perform a box selection to generate at least one labeling area R2 and acquire image coordinates of the labeling area R2. In this embodiment, the correction step S5 generates the at least one labeling area R2 by the EAST target detection neural network model, and update the range boundary of the at least one view area R1 according to the image coordinates of the labeling area R2 to make the updated at least one view area R1′ not covering the labeling area R2. For example, an image for training of the basic model established by the EAST may include an image with only a number, an annotation or a symbol, an image with a number and an annotation, an image with a number and a symbol, an image with an annotation and a symbol, and an image with a number, an annotation and a symbol.

On the other hand, the correction step S5 excludes dimension information such as a dimension boundary line, a dimension line, an arrow or/and a leader line from the at least one view area R1 by an image processing technology to reduce the range boundary of the at least one view area R1. In this embodiment, the image processing technology may use erosion and dilation in the morphology to update the range boundary of the at least one view area R1. Preferably, the correction step S5 excludes all the dimension information of the engineering drawing image from the view area R1 by the image processing technology and only view information of the engineering drawing image is remained to update the range boundary of the at least one view area R1.

In addition, it should be noted that except that the correction step S5 generates the at least one labeling area R2 independently by the target detection network and update the range boundary of the at least one view area R1 according to the image coordinates of the labeling area R2, or update the range boundary of the at least one view area R1 independently by the target detection network. Preferably, the correction step S5 updates the range boundary of the at least one view area R1 by the target detection network and the image processing technology, which may be understood by one of ordinary skill in the art.

The above method embodiment of the present invention may further be written into computer programs, such as an electronic component viewing direction analysis program for analyzing the at least one engineering drawing image of the electronic component to acquire a viewing direction of the electronic component, with program language such as C++, Java, Python or Julia. The manner of writing the program code may be understood by one of ordinary skill in the art, and may be used to generate a computer program product with a stored program. The computer program product may perform the above method embodiment of the present invention after a computer system loads and executes the stored program.

The computer program product may further be stored on a computer readable medium with the stored program, such as an optical disc, a hard disk, a Universal Serial Bus (USB) flash drive, various memory cards, and cloud or virtual storage spaces. The computer readable medium may perform the above method embodiment of the present invention after a computer system loads and execute the stored program, to serve as a basis that software and hardware of the computer system of the present invention operate collaboratively.

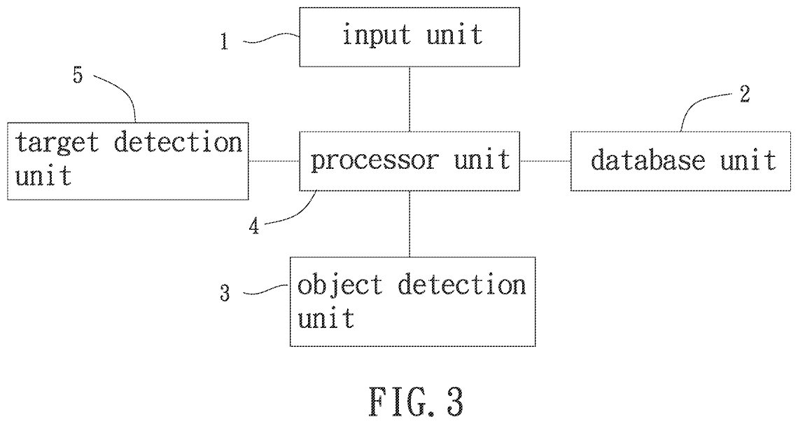

Referring to FIG. 3, which is a preferred embodiment of a system for analyzing a viewing direction of an electronic component according to the present invention, the system includes an input unit 1, a database 2, an object detection unit 3 and a processor unit 4. The input unit 1, the database 2 and the object detection unit 3 are electrically connected to the processor unit 4, respectively.

The input unit 1 inputs a package type and a file image of an electronic component. The file image has at least one engineering drawing image, and the at least one engineering drawing image is a view of the electronic component in at least one viewing direction. In this embodiment, the file image may be a digital image of an electronic component engineering drawing specification, and the at least one engineering drawing image includes at least one of a top view, a bottom view, a side view, a cross-sectional view and a land pattern view. Specifically, the input unit 1 is a device with a function of receiving text and image files.

The database unit 2 may store respective viewing direction detection models of a plurality of different package types of electronic components in advance so as to identify the viewing direction of the engineering drawing image of the electronic component. For example, the plurality of package types may include package types of the electronic components such as BGA, QFP, PLCO, DIP, SIP, SOP, SOJ, connector, etc. However, the present invention is not limited in this regard.

The object detection unit 3 detects the at least one engineering drawing image from the file image by the viewing direction detection model so as to identify the viewing direction of the at least one engineering drawing image. For example, the viewing direction detection model may a multi-input multi-output deep learning model. However, the present invention is not limited in this regard.

The processor unit 4 is electrically connected to the input unit 1, the database unit 2 and the object detection unit 3. The processor unit 4 queries a viewing direction detection model meeting the package type of the electronic component from the database unit 2 and inputs the file image into the viewing direction detection model, such that the viewing direction detection model detects the at least one engineering drawing image from the file image to identify and output the viewing direction of the at least one engineering drawing image. For example, the processor unit 4 may label the viewing direction adjacent to the at least one engineering drawing image of the file image in a text manner, such that a user can know the viewing direction of the engineering drawing image.

The system for analyzing the viewing direction of the electronic component according to the present invention may further include a target detection unit 5. The target detection unit 5 is electrically connected to the processor unit 4, and the object detection unit 5 may correct the at least one view area box-selected by the object detection unit 3 to exclude the dimension information of the engineering drawing image from the at least one view area. Thus, only view information of the engineering drawing image in the at least one view area is remained.

Specifically, the object detection unit 3 may detect at least one engineering drawing image from the file image and perform a box selection to generate at least one view area. The processor unit 4 detects a number, an annotation or/and a symbol by the object detection unit 5 and performs a box selection to generate at least one labeling area and acquire image coordinates of the labeling area. The target detection unit 5 updates the range boundary of the at least one view area according to the image coordinates of the labeling area, such that the updated at least one view area does not cover the labeling area. In this embodiment the target detection unit 5 may be convolutional neural network-based target detection neural network model such as EAST, RCNN, Fast RCNN, Faster RCNN or SSD, but is not limited thereto.

On the other hand, the processor unit 4 may exclude a dimension boundary line, a dimension line, an arrow or/and a leader line from the at least one view area by a morphology image processing technology in an image processing manner such as erosion and dilation to reduce the range boundary of the at least one view area. Preferably, the processor unit 4 may exclude all the dimension information of the engineering drawing image in the at least one view area by the image processing technology and only view information of the engineering drawing image is remained to update the range boundary of the at least one view area.

In summary, according to the method and system for analyzing the viewing direction of the electronic component, the computer program product with the stored program and the computer readable medium with the stored program according to the present invention, data meeting a package type of the electronic component can be queried from the database to acquire a viewing direction detection model for identifying the viewing direction of at least one engineering drawing image of the electronic component, and the viewing direction of the at least one engineering drawing image is identified by the viewing direction detection model. Thus, the present invention has the effect of reducing artificial misjudgment.

Although the invention has been described in detail with reference to its presently preferable embodiments, it will be understood by one of ordinary skill in the art that various modifications can be made without departing from the spirit and the scope of the invention, as set forth in the appended claims.

What is claimed is:

1. A method for analyzing a viewing direction of an electronic component, comprising:
inputting a package type and a file image of an electronic component, wherein the file image has at least one engineering drawing image, and the at least one engineering drawing image is a view of the electronic component in at least one viewing direction;
querying and acquiring a viewing direction detection model meeting the package type from a database, wherein the database stores respective viewing direction detection models of different package types of electronic components;
inputting the file image into the viewing direction detection model of the package type to identify the viewing direction of the at least one engineering drawing image; and
outputting the viewing direction of the at least one engineering drawing image of the electronic component.

2. The method for analyzing the viewing direction of the electronic component as claimed in claim 1, wherein the at least one engineering drawing image includes at least one of a top view, a bottom view, a side view, a cross-sectional view and a land pattern view.

3. The method for analyzing the viewing direction of the electronic component as claimed in claim 1, wherein the viewing direction detection model adopts an object detection neural network model to detect the at least one engineering drawing image and perform a box selection to generate at least one view area, and the viewing direction detection model identifies an engineering drawing image in the at least one view area to identify the viewing direction of the at least one engineering drawing image.

4. The method for analyzing the viewing direction of the electronic component as claimed in claim 1, wherein the viewing direction detection model detects the at least one engineering drawing image and performs a box selection to generate at least one view area, detects numbers, annotations or/and symbols in the at least one view area, performs a box selection to generate at least one labeling area and acquire image coordinates of the labeling area, and updates a range boundary of the at least one view area according to the image coordinates of the labeling area to make the updated at least one view area not covering the labeling area.

5. The method for analyzing the viewing direction of the electronic component as claimed in claim 4, further comprising excluding a dimension boundary line, a dimension line, an arrow or/and a leader line from the at least one view area by a morphology image processing technology to reduce the range boundary of the at least one view area.

6. A computer program product with a stored program, which is capable of performing the method for analyzing the viewing direction of the electronic component as claimed in claim 1 after a computer system loads and executes the stored program.

7. A computer readable medium with a stored program, which is capable of performing the method for analyzing the viewing direction of the electronic component as claimed in claim 1 after a computer system loads and executes the stored program.

8. A system for analyzing a viewing direction of an electronic component, comprising:
an input unit, configured to input a package type and a file image of an electronic component, wherein the file image has at least one engineering drawing image, and the at least one engineering drawing image is a view of the electronic component in at least one viewing direction;
a database unit, configured to store respective viewing direction detection models of different package types of electronic components;
an object detection unit, configured to detect at least one engineering drawing image from the file image to identify a viewing direction of the at least one engineering drawing image; and
a processor unit, electrically connected to the input unit, the database unit and the object detection unit, wherein the processor unit is configured to query a viewing direction detection model meeting the package type of the electronic component from the database unit and input the file image into the viewing direction detection model to make the viewing direction detection model detect the at least one engineering drawing image from the file image to identify and output the viewing direction of the at least one engineering drawing image.

9. The system for analyzing the viewing direction of the electronic component as claimed in claim 8, further comprising a target detection unit, wherein the target detection unit is electrically connected to the processor unit, the object detection unit detects the at least one engineering drawing image and performs a box selection to generate at least one view area, the processor unit detects numbers, annotations or/and symbols in the at least one view area by the target detection unit and performs a box selection to generate at least one labeling area and acquire image coordinates of the labeling area, and the target detection unit updates a range boundary of the at least one view area according to the image coordinates of the labeling area to make the updated at least one view area not covering the labeling area.

10. The system for analyzing the viewing direction of the electronic component as claimed in claim 8, wherein the processor unit excludes a dimension boundary line, a dimension line, an arrow or/and a leader line from the at least one view area by a morphology image processing technology to reduce the range boundary of the at least one view area.

11. The system for analyzing the viewing direction of the electronic component as claimed in claim 9, wherein the processor unit excludes a dimension boundary line, a dimension line, an arrow or/and a leader line from the at least one view area by a morphology image processing technology to reduce the range boundary of the at least one view area.
